(19) United States
(12) Patent Application Publication
(10) Pub. No.: US 2007/0195883 A1
(43) Pub. Date: Aug. 23, 2007

(54) Media signal processing method, corresponding system, and application thereof in a resource-scalable motion estimator

(75) Inventors: Christian Hentschel, Cottbus (DE); Robertus Hendricus Wubben, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,886

(22) PCT Filed: Mar. 15, 2005
(86) PCT No.: PCT/IB05/50905

§ 371 Date: Sep. 14, 2006

(30) Foreign Application Priority Data
Mar. 19, 2004 (EP) 04300152.8

(51) Int. Cl. H04N 7/12; H04B 1/66; H04N 11/04; H04N 11/02

(52) U.S. Cl. 375/240.16; 375/240.26; 375/240.24

(57) ABSTRACT

The invention relates to a method of processing, in a media signal processing system, a media signal available in the form of successive sets of media data packets. The method, which performs one or a plurality of functions among which at least one of them can be carried out with different levels of scalability resulting in different output qualities and resource demands, comprises the steps of—requesting a resource to provide a plurality of system outputs; —allocating a predetermined budget to the method in order to enable operating the method at a given level of scalability; —measuring an expression called progress that takes into account the processed data; —measuring at least one media processing specific resource used during operation; —on the basis of regulation parameters consisting of the allocated budget and said measurements, performing a load regulation by allocating modified resources for media signal processing.

### FIELD OF THE INVENTION

The invention relates to a method of processing, in a media signal processing system, a media signal available in the form of successive sets of media data packets, said processing method performing one or a plurality of functions among which at least one of them can be carried out with different levels of scalability resulting in different output qualities and resource demands.

The invention also relates to a corresponding processing device allowing to carry out said method, and to applications of said processing method.

### BACKGROUND OF THE INVENTION

Software algorithms doing media (especially video) processing are increasingly executed on programmable components. These algorithms have usually data dependent resource usage. Since worst case resource allocation is difficult to predict and, moreover, not desirable for efficient, cost-effective implementation, a media processing algorithm has generally to deal with limited resources, still providing good output quality without sacrificing stability and robustness. Scalable media algorithms, which are well suited for software implementation, allow a trade-off between output quality and resource usage. However, the data dependent processing results in varying resource usage, and the resource fluctuations may be larger than the system can accept.

A first example of a device carrying out a resource-scalable algorithm is for instance a motion estimator, such as the one described in “Complexity scalable motion estimation”, by R. Braspenning, G. de Haan and C. Hentschel, International Conference on Visual Communications and Image Processing (VCIP), Proceedings, San Jose (USA), January 2002, pp. 442-453. In such a motion estimator, the resource usage may highly fluctuate, depending on the temporal activities and spatial content properties. In order to stay within the provided budget (or resources), this motion estimator contains a regulator which allows to keep the load close to a specified target.

However, with such a regulator, the regulation parameters are calculated and adjusted on a frame basis and the threshold parameter “resource/quality setting” is fixed for an entire frame, and no differentiation is therefore possible for more or less active areas within this frame. Also the resource usage is determined for an entire frame and used thereafter. Thus no adaptation within a frame is possible and, as a result, the regulation often fails after shot changes, using much more resources than the specified target. Finally, it appears that the fluctuation in resource usage per frame is still too high for robust and stable applications.

A second example of a solution allowing to carry out a resource-scalable algorithm is described in the document WO 03/050758 (PHNL010900). The method described in said document, which can adapt to changing requirements for a media signal (said requirements being for instance a non-predictable demand for quality level and therefore for more processing power), comprises the steps of allocating a budget to enable operating at a first quality level, determining a so-called progress and the budget used during operation (thanks to a measure of the actual use of resources), and setting a second quality level for the media signal processing (based on said progress, the allocated budget and the budget actually used).

It can be noted, however, that this regulating method influences mainly quality levels of an algorithm and only indirectly resource usage, not mentioned. The correlation between quality level and resource usage is weak or not suitable, especially for media data dependent processing. Moreover, the budget used during operation is determined by system properties outside the processing algorithm, since budget information includes measurements about parameters outside the processing algorithm, such as CPU cycles, time used, stall cycles, bus bandwidth, memory access, etc. The regulation is consequently determined by the processing hardware, with a heavy interaction with the processing algorithm, and re-use on other platforms or configurations is problematic, since the entire system must be optimized for the overall, specific application. This is often not possible because some system properties on the programmable components are difficult to measure or to predict (such as bus bandwidth, stall cycles, etc. . . . ).

### SUMMARY OF THE INVENTION

It therefore appears as desirable to provide a load-balancing regulation for media (video) processing algorithms, with no external control required in order to allow an easy re-use on other platforms or product family members, and to base said load regulation on assigned media processing specific budget and internal media processing specific measurements, ignoring other system specific parameters. Moreover, said load regulation has preferably to be done for a set of video data packets such as a frame, while the regulation parameter(s) are adapted within a frame. It is also required to verify that the regulation properties are independent of the amount of data already processed and that said regulation, close to a specific resource budget per frame, is independent of the input data properties (optionally, the regulation will have to regulate resource usage to individually pre-determined budgets in areas or segments smaller than a frame and of any regular or irregular shape and size, still providing regulation to an overall budget for the entire frame).

It is therefore an object of the invention to propose a processing method in which a load regulation including said characteristics and advantages is provided.

To this end, the invention relates to a method such as defined in the introductory paragraph of the description and which is moreover characterized in that it comprises the steps of:

requesting a resource to provide a plurality of system outputs

allocating a predetermined budget to the method in order to enable operating the method at a given level of scalability;

measuring a so-called progress taking into account the data that has been processed;

measuring at least one media processing specific resource used during operation of the method;

on the basis of regulation parameters consisting of said allocated budget and said measurements, performing a load regulation by allocating modified resources for media signal processing.

The advantages of the proposed method are the following ones:

(a) very good regulation to a specified target (the assigned budget)

(b) stable and robust media processing on programmable components with limited resources;

(c) the regulation is a part of the media processing algorithm and does not require external regulation components: the algorithm with its regulation is therefore easily portable to other platforms or product family members;

(d) a differentiation for more or less active areas within a frame is possible, in view of an optimized perceived picture quality at given resources.

According to a specific embodiment of the invention, the regulation parameters are preferably adapted within a frame with regular borders, but they may also be adapted within a frame subdivided into segments in a regular grid, a separate budget being then allocated to at least one of said segments, generally at least the first one. However, a separate budget may also be allocated to each of said segments, on the basis of content dependent segment properties.

In another embodiment of the invention, the regulation parameters may also be adapted within a frame subdivided into irregular parts, a specific budget being allocated to each of said irregular parts.

It is another object of the invention to propose a media signal processing system allowing to carry out the processing method according to the invention.

To this end, the invention relates to a media signal processing system for processing successive sets of video data packets and comprising one or a plurality of functional circuits among which at least one of the functions performed by said circuits can be carried out with different levels of scalability resulting in different output qualities and resource demands, said system comprising a regulation device consisting of a feedback control loop provided for dynamically changing the resource needs of the system as a function of a so-called deviation applied to at least one variable parameter of said scalable(s) function(s) and calculated by means of a computation of the difference between expected and real usage during an assigned period.

It is still another object of the invention to use said processing method in an application such as a motion estimation process.

To this end, the invention relates to the application of the media signal processing method to a load regulation method for use in a resource-scalable motion estimator testing a target number of vector candidates and including a load-balancing regulation for an input video data stream consisting of successive frames that comprise successive lines of pixels and are subdivided into contiguous blocks, said load regulation method comprising the steps of:

requesting a resource to provide a plurality of system outputs in the form of a given number of estimated motion vector candidates;

allocating a predetermined budget per frame in order to enable operating at a defined quality level;

measuring a so-called progress that takes into account the data that have been processed;

measuring the resource used during operation of the method;

on the basis of regulation parameters consisting of said allocated budget and said measurements, performing a load regulation by allocating modified resources for said media signal processing.

It is still another object of the invention to use the proposed processing method in an application such as a sharpness enhancement process.

To this end, the invention relates to the application of the media processing method to a load regulation method for use in a sharpness enhancement process, said load regulation method comprising the steps of:

requesting a resource to provide a plurality of system outputs in the form of a given number of block activities and associated decisions;

allocating a predetermined budget per frame in order to enable operating at a defined quality level;

measuring a so-called progress that takes into account the data that have been processed;

measuring the resource used during operation of the method;

on the basis of regulation parameters consisting of said allocated budget and said measurements, performing a load regulation by allocating modified resources for said media signal processing.

### BRIEF DESCRIPTION OF THE DRAWINGS

The present invention will now be described, by way of example, with reference to the accompanying drawings in which:

FIG. 1 illustrates a progress-based media processing regulator according to the invention;

FIGS. 2 and 3 illustrate two applications of the regulator according to the invention;

FIG. 4 illustrates a more specific progress-based regulator according to the invention;

FIG. 5 shows an example of conventional low-pass filter provided in the regulator of FIG. 4;

FIG. 6 shows, with respect to FIG. 4, another example of progress-based regulator according to the invention;

FIG. 7 shows a division of an image into segments and of one of said segments into regulator parts and into blocks;

FIG. 8 illustrates a further example of progress-based regulator according to the invention;

FIG. 9 is an example of flowchart depicting how said regulator of FIG. 6 works.

### DETAILED DESCRIPTION OF THE INVENTION

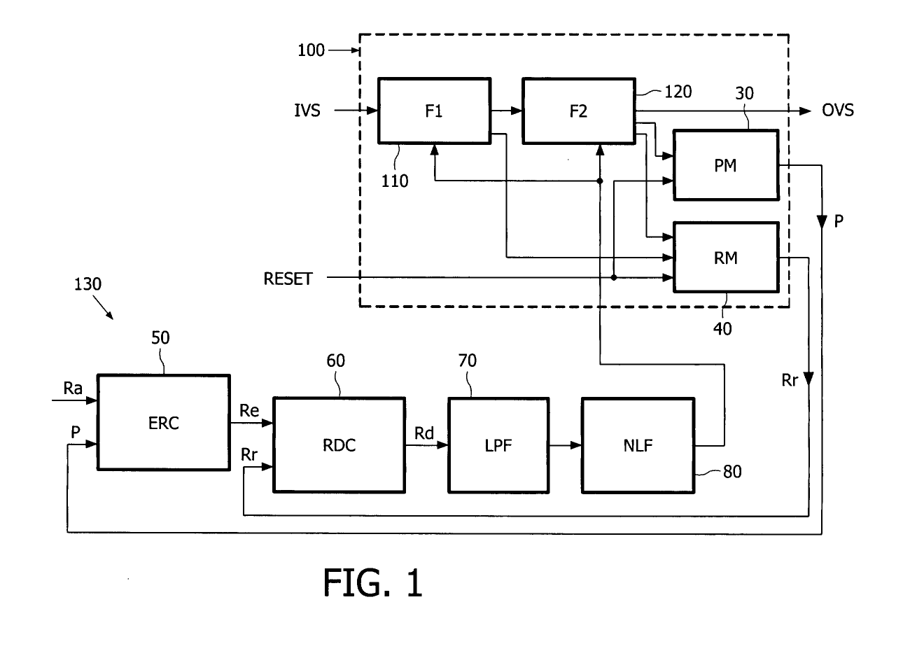

According to the proposed approach, FIG. 1 shows the general structure of a progress-based media processing regulator allowing to satisfy the requirements listed above. The illustrated regulator comprises a basic stage 100 for media processing. This stage may include several blocks, the number of which is not essential for the invention that will be described below. In the illustrated example, which is not a limitation of the invention, said stage includes for instance, in series, a first circuit 110 performing a function 1 (F1) and a second circuit 120 performing a function 2 (F2). The basic algorithm implemented in said stage 100 may be for instance a motion estimation, but the principle is, more generally, applicable to any scalable algorithm having data dependent resource usage (another example would be for instance an algorithm for sharpness enhancement in the most relevant areas of individual pictures).

In the stage 100, the first circuit 110 receives an input video signal (IVS) and the second circuit 120 delivers an output video signal (OVS). A regulation loop 130 is then associated to the stage 100. In the stage 100, a third circuit 30 (PM, for progress measurement) allows to measure an expression called progress and determined in fact by a ratio between the number of processed data of the input signal and the total amount of data that has to be processed in the assigned period (for instance a frame period). Said circuit 30 may for instance deliver an indication p. Also in the stage 100, a fourth circuit 40 (RM, for resource measurement) allows to measure at least one media specific resource used. Said circuit 40 delivers a number Rr which is the real, accumulated number of resources used by the processing algorithm. The output signal p of the circuit 30 is received by a fifth circuit 50 (ERC, for “expected resource usage” calculation) and the output signal Rr of the circuit 40 is received by a sixth circuit 60 (RDC, for “resource deviation calculation”). Circuits 30 and 40 have an input RESET for resetting them at the start of the measurement period.

The measured progress p, available at the output of the circuit 30, is used to weigh the target Ra (or budget per assigned period) available at the input of the circuit 50, and the weighted target Re thus obtained at the output of the circuit 50 is received on a second input of the circuit 60, which, on the basis of the values Re and Rr, computes a deviation Rd from the weighted target. This deviation Rd is the resource/quality setting sent towards the circuit 120 in order to perform the requested regulation. Between this output Rd of the circuit 60 and the input of the circuit 120, a low-pass filter 70 (LPF) and a circuit 80 (NLF) having a non linear function may be provided, each of these two circuits being optional (in FIG. 1, they are shown).

These principles may be applied first to a frame with regular borders, but it is not the only possible embodiment. Media processing may also require different resources for different parts of an image, such as stationary image parts, moving areas, textured areas, flat areas, motion vector fields with similar direction and velocity, etc., for example in order to achieve an approximately constant perceptual quality. These image parts may be moreover divided into segments, which themselves may be either in a regular grid or irregular, based on their content. After such a segmentation, each segment may be assigned a priority or a relative budget depending on the major, content dependent segment properties. In addition, a different priority may be assigned for the beginning of an image, for faster convergence.

This general load regulation method may be used in numerous applications, and for instance in a resource-scalable motion estimator, for example of the type described in the document “Complexity scalable motion estimation” already cited. As explained in said document, motion estimation, in general, solves the problem of, given two luminance image f(x,t−1) and f(x,t), finding a vector field d(x,t) such that
f(x,t−1)=f(x+d(x,t),t) (1)
In fact, in order to obtain a stable solution, the estimation of the function d(x,t) is performed not for every pixel but for a group of pixels, e.g. an 8×8 block. This introduces the constraint that:
d(x,t)=d(x′,t), ∀x′∈B(x), (2)
where B(x) is the block of pixels at position x, i.e.
B(x)={x′|x′ᵢ div βᵢ, i=0, 1} (3)
and βᵢ are the block dimensions. For convenience, one defines the set BC (for “Block Coordinates”) that contains all the coordinates at block positions, i.e.
BC={x|xᵢmod βᵢ, =0ᵢ; i=0, 1} (4)
The estimation algorithm is then defined as follows. Consider a block at position x∈ BC. The set PC (for “Previously Computed”) consists of the positions of the blocks that have already been estimated at the current time instance t. A candidate set CS is constructed, i.e.
CS={cᵢ|i=0, . . . , |CS|−1} (5)
A candidate vector cᵢ is associated with a block position xᵢ, which is related to the current position x through the scanning order (denoted by unit vector s₀ and s₁, e.g. s₀=(1, 0) and s₁=(0, 1)). The block position xᵢ can be described using the relative block position vector δ, i.e.:
xᵢ=x+δ₀β₀s₀+δ₁β₁s₁ (6)
If the vector δ satisfies the condition (δ₁<0)v(δ₁=0ˆδ₀<0), then the block position is a neighboring block that has already been processed at the current time t, i.e. xᵢ ∈ PC, and one can take its output vector as a candidate. For every candidate vector cᵢ ∈ CS, a match error ε is computed according to:

$$ɛ ( c , x , t ) = {\sum }_{{x}^{′} ∈ B ( x )} \vert f ( {x}^{′} , t ) - f ( {x}^{′} - c , t - 1 ) \vert \qquad ( 7 )$$

The candidate vector with lowest match error, cₘᵢₙ, is then assigned as the output displacement vector, i.e.:

$${c}_{min} = {arg min ( ɛ ( c , x , t ) )}_{c ∈ Cs} \qquad ( 8 )$$

and, hence:
∀x′∈B(x)d(x′, t)=cₘᵢₙ (9)
Finally, the position x is added to the set PC, i.e. PC:=PC∪{x}.

In the given example of a motion estimation, the resource-scalable motion estimator that is described uses for instance (although other mechanisms can be devised to make a motion estimator scalable) an expression called block hopping threshold to determine whether or not to test another vector candidate for a given block within an image. Block hopping refers to a technique provided for selecting the most important blocks for processing. According to said technique, motion vectors for a given block are simply copied from a neighbouring block, unless it results in a matching error higher than a variable threshold. In the present case, this variable threshold is controlled with a feedback loop that keeps the resource usage below a programmable level. This block hopping mechanism requires at least one SAD (Sum of Absolute Differences) to be calculated. As the average number of SAD calculations per block can never be lower than one and an average close to one SAD per block is very hard to reach with an acceptable quality, an additional mechanism is needed: block skipping, which allows to prevent spending resources on blocks for which the candidate selection performs poorly (for instance, on blocks that contain no or very low contrast textures).

Varying the block-hopping threshold therefore affects the number of candidates that are tested and, consequently, the load of the motion estimator. This block-hopping threshold is updated by a load-balancing regulator each time the motion estimator has processed an horizontal line of blocks (or block line). After having processed a block line with a given block-hopping threshold, the motion estimator outputs the real average number of candidates for all the blocks that have been processed in the image. At the end of the concerned image, said average number of candidates should be close to the specified target average number of candidates, i.e. the error should be close to zero. In fact, given the residual error value, which is the difference observed between the specified and real average numbers of candidates, a correction value has to be calculated and this correction has to be translated into the proper value of the block-hopping threshold for the next block line, generally according to a non-linear translation function (but it may be also by means of a multiplication by a constant factor).

It can be observed, however, that only a deviation from the target at the end of the image is important, not for each block line individually. Furthermore, large load differences between the block lines should be avoided since they could result in visible differences in quality between them. It is therefore proposed, in the motion estimator here described, to take into account the relative position of the block line in the image. This relative position, called the progress, is used to weight the target number of candidates for the whole image, in order to get a weighted target number of candidates for all the block lines that have been processed. The deviation of the real number of candidates from the weighted target is then used to derive the block-hopping threshold. The weighting of the target with the progress makes the regulator independent of the block line position.

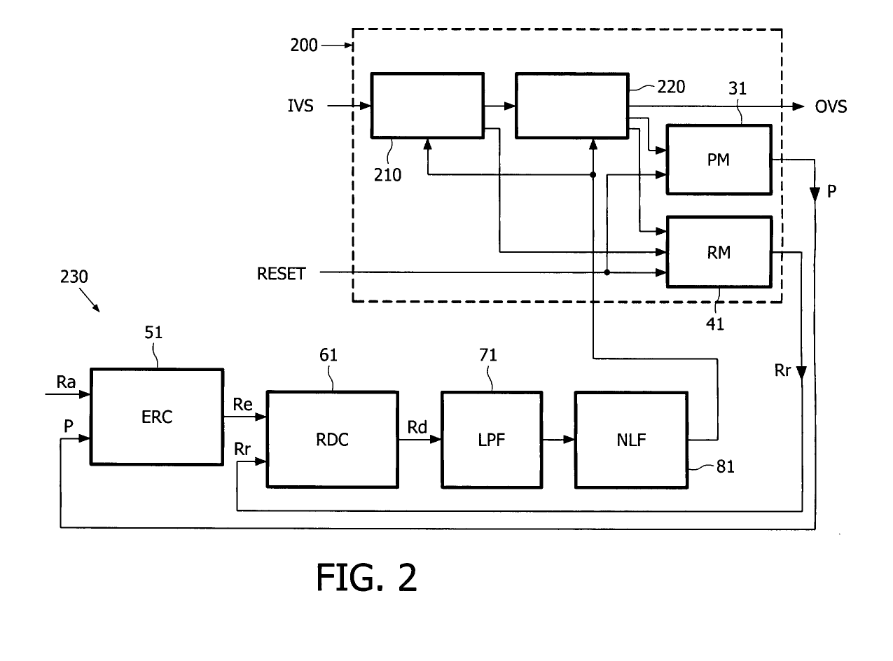

In FIG. 2, the approach illustrated in FIG. 1 is applied to a basic algorithm for motion estimation. According to the embodiment shown in FIG. 2, a motion estimator 200 includes circuits 210 and 220, provided for performing the motion estimation itself. A regulation loop 230 is then associated to the motion estimator 200 and comprises circuits 51 to 81 similar to the circuits 50 to 80. In the stage 200, a third circuit 31 (PM), delivering an indication p, allows to measure the progress, determined by a ratio between the number of processed data of the input signal and the total amount of data that has to be processed in the assigned period (for instance a frame period). Also in the stage 200, a fourth circuit 41 (RM), allowing to measure the resource used, delivers the number Rr which is the real, accumulated number of resources used by the processing algorithm. The output signal p of the circuit 31 is received by the fifth circuit 51, and the output signal Rr of the circuit 41 is received by a first input of the sixth circuit 61. The measured progress p available at the output of the circuit 31 is used to weigh the target Ra (or budget per assigned period) received at the input of the circuit 51, and the weighted target Re thus obtained is received on a second input of the circuit 61, which, on the basis of said values Re and Rr, computes the deviation Rd from the weighted target. This deviation is the resource/quality setting sent towards the circuit 220 in order to perform the requested regulation. Between the output Rd of the circuit 61 and the corresponding input of the circuit 220, a low-pass filter 71 and a circuit 81 having a non-linear function may be provided as in FIG. 1, each of these two circuits being optional (in FIG. 2, they are shown).

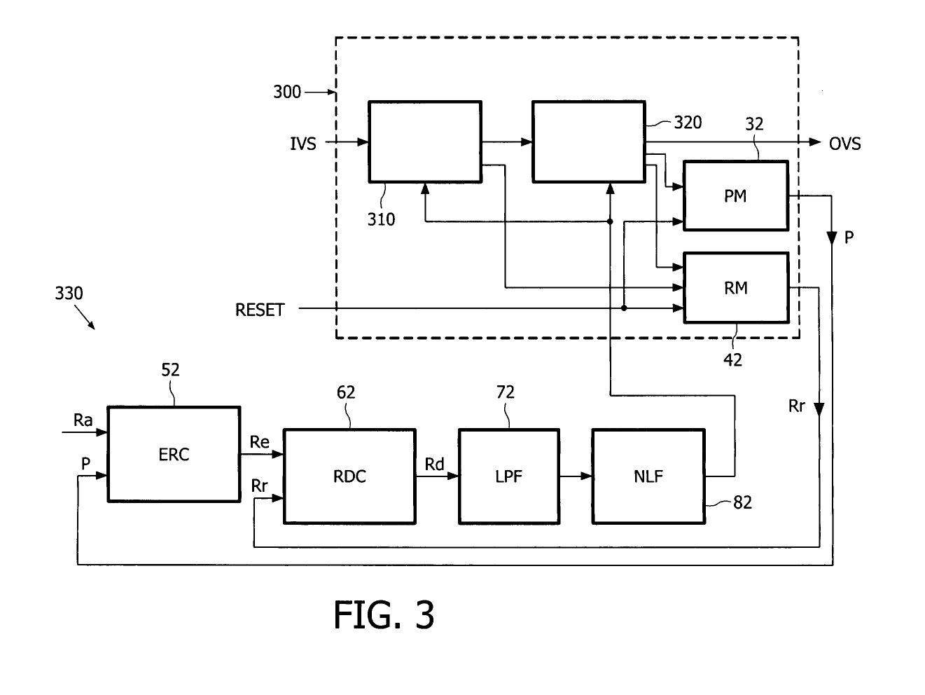

In FIG. 3, the approach of FIG. 1 is now used in another situation, for carrying out a basic algorithm for sharpness enhancement. According to the illustrated embodiment, the progress-based regulation now comprises a basic stage 300, which itself includes a first circuit 310, provided for a calculation of block activity (the activity can be for example high, when it corresponds to a texture with a high contrast, or medium or low for a medium contrast or a low contrast texture) and decision on processing (corresponding decisions may be for instance: sharpening, i.e. increasing local contrast, or do nothing, or smoothening, i.e. reducing the noise), and a second circuit 320, provided for block processing. In this example, these properties (for the sharpness enhancement algorithm) lead to content dependent resource usage: for local regulation, it is possible to use two different threshold levels (between “do nothing” and “sharpening”, and between “do nothing” and “smoothening”) that can be shifted to reduce or increase the resource usage (“do nothing” corresponding to the least resources). A regulation loop 330 is then associated to the motion estimator 300 and comprises circuits 52 to 82 similar to the circuits 50 to 80. In the stage 300, the third circuit 32 (PM), delivering an indication p, allows to measure the progress, determined by a ratio between the number of processed data of the input signal and the total amount of data that has to be processed in the assigned period (for instance a frame period). Also in the stage 300, the fourth circuit 42 (RM), allowing to measure the resource used, delivers the number Rr which is the real, accumulated number of resources used by the processing algorithm. The output signal p of the circuit 32 is received by the fifth circuit 52, and the output signal Rr of the circuit 42 is received by the sixth circuit 62. The measured progress, available at the output of the circuit 32, is used to weigh the target Ra (or budget per assigned period) available at the input of the circuit 52, and the weighted target Re thus obtained is received on a second input of the circuit 62, which, on the basis of said values Re and Rr, computes the deviation from the weighted target. This deviation is the resource/quality setting sent towards the circuit 320 in order to perform the requested regulation. Between the output Rd of the circuit 62 and the input of the circuit 320, a low-pass filter 72 and a circuit 82 having a non linear function may be provided as in FIGS. 1 and 2, each of these two circuits being optional (in FIG. 3, they are shown).

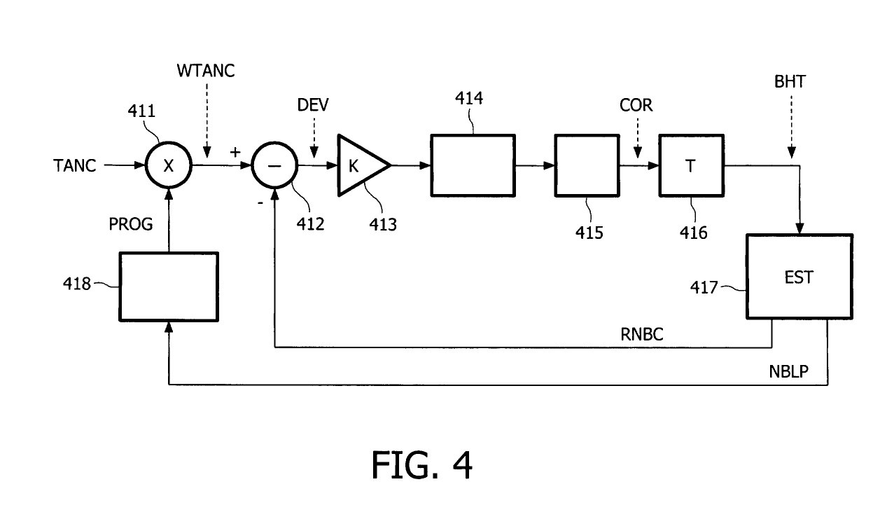

With respect to the application illustrated in FIG. 2, a more specific embodiment is depicted in FIG. 4, that shows a specific example of progress-based regulator according to the invention. In said FIG. 4, an input target number of candidates TANC is received by a multiplier 411, followed in series by a subtracter 412, a low-pass filter 414, a limiter 415 (i.e. a circuit with a non-linear function), a translator 416 (T) and a motion estimator 417 (EST). The filter 414 and the limiter 415 are optional. At the output of the motion estimator 417, two data are available: the number of block lines processed NBLP and the real number of candidates RNBC. An amplifier 413 with a gain K may be provided between the subtracter 412 and the low-pass filter 414. In the present specific embodiment of a regulation per line of blocks, the progress is obtained by determining in a calculating circuit 418 the ratio PROG=NBLP/TNBL, where TNBL is the total number of block lines in a frame, and received on a second input of the multiplier 411 for weighting the input target number of candidates TANC. The weighted target number of candidates WTANC available at the output of the multiplier 411 is received on a first input of the subtracter 412, the negative input of which receives the real number of candidates RNBC. The difference, called the deviation DEV, between WTANC and RNBC, is multiplied by a gain factor K in the amplifier 413, and low-pass filtered in the filter 414 and limited in the limiter 415 (if these two last circuits, which are optional, have been provided). The correction value COR available at the output of the limiter 415 (or at the output of the amplifier 413 if the filter 414 and the limiter 415 are not present) is translated into a value of block-hopping threshold BHT, according to a translation function which is linear or non-linear as said above. In the experiments that have been performed (but are in no way a limitation of the present invention), this threshold BHT was given by the following expression:

$$BHT = \frac{\begin{matrix}3 , 3 * ( total number of blocks ) - \\ ( target number of candidates ) + correction\end{matrix}}{- 1 , 9 * ( total number of blocks )}$$

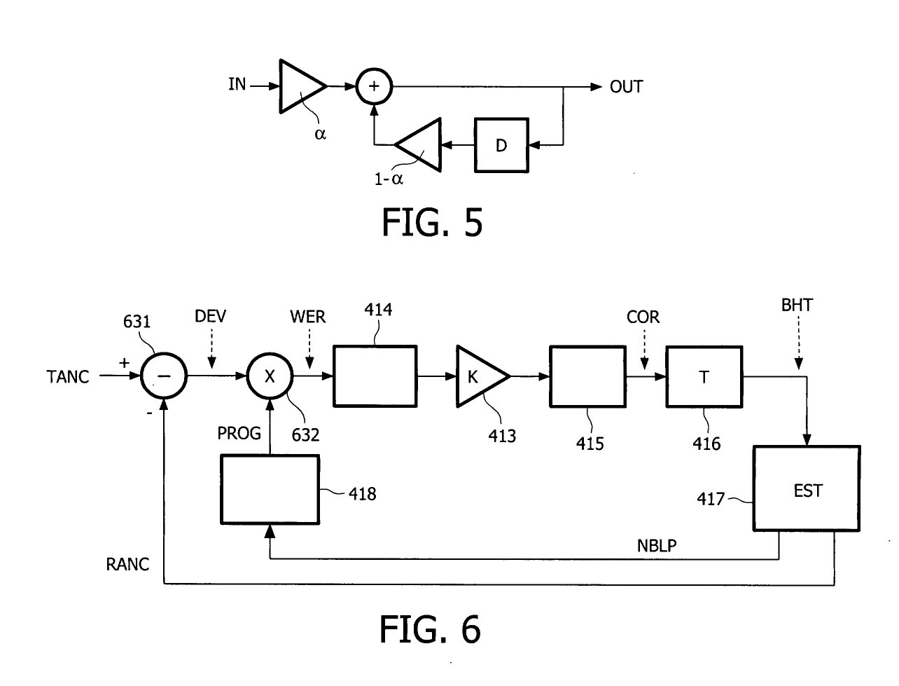

this function being preferably implemented by means of a look-up table. The block-hopping threshold BHT is then received by the motion estimator 417. For the low-pass filter, a conventional first-order IIR low-pass filter may be used, such as the example of filter shown in FIG. 5. The delay element D of this filter and the block-hopping threshold are reset at the start of every new image.

An alternative schematic representation of the progress-based regulator of FIG. 4 can be proposed in FIG. 6, in which the circuits already present in the implementation of FIG. 4 are similarly referenced. The input target average number of candidates TANC is received by a subtracter 631, followed in series by a multiplier 632, the low-pass filter 414, the amplifier 413, the limiter 415, the translator 416 and the motion estimator 417, at the output of which two data are available: the number of block lines processed NBLP and the real average number of candidates RANC. The progress, computed as previously in the calculating circuit 418, is received on a second input of the multiplier 632, now provided between the subtracter 631 and the low-pass filter 414. The other output of the motion estimator 417, the real average number of candidates RANC, is received by the negative input of the subtracter 631. The difference, also called the deviation DEV, between the input target average number of candidates TANC and the real average number of candidates RANC is received on the first input of the multiplier 632 and multiplied by the progress previously computed in the calculating circuit 418, said multiplier delivering a weighted error WER, then processed as previously in the circuits 414, 413, 415, 416 and 417.

A relative deviation at the beginning of the image will result in only a small change of the block-hopping threshold, that will however affect all the remaining block lines in the image. On the contrary, a relative deviation near the end of the image will result in a larger change of the threshold in order to meet the target. Overall, the regulation is equal or comparable to the regulator with absolute deviations as shown in FIG. 4.

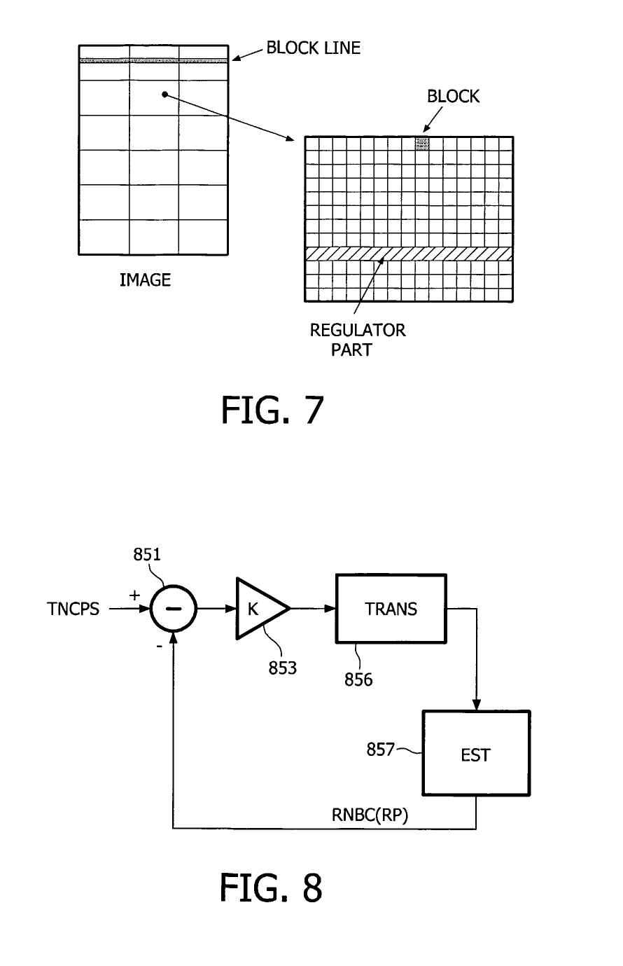

In the case of the above-described embodiments, the available resources have been distributed evenly over the image, i.e. each part of the image has been given the same average number of resources as every other part. However, this does not always lead to the best output quality. A third implementation of progress-based regulator can then be proposed, in which separate load targets are used for different image parts, depending on the image content. According to this third implementation, each image is, as shown in the left part of FIG. 7, divided into segments (in the present case, into equally-sized rectangular segments) for which load targets are determined (in the example of FIG. 7, the image, that includes 3240 blocks of 8×8 pixels, has been divided into 3×6=18 segments, and each segment, as illustrated in the right part of FIG. 7, comprises 12 regulator parts and 15×12=180 blocks, i.e. 15 blocks of 8×8 pixels per regulator part). These load targets, expressed as the average number of candidates per block, are determined in such a way that they have the following properties:

(a) the average load target of all image segments are the same as the specified load target of the whole image;

(b) since the motion estimator cannot spend more than a given number of candidates per block, the maximum load target does not exceed said given number of candidates per block;

(c) similarly, since the motion estimator cannot spend less than a given number of candidates per block, the minimum load target does not fall below approximately said given number of candidates per block.

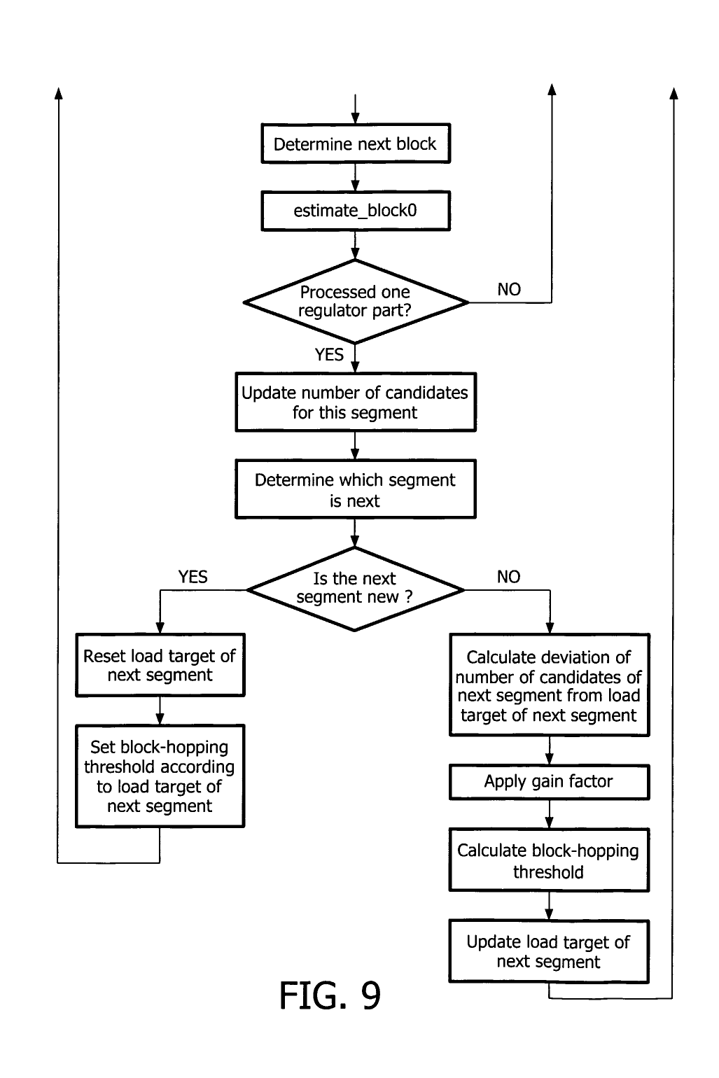

A schematic diagram of a regulator that uses separate load targets for the various image segments is shown in FIG. 8. The input target number of candidates for all processed regulator parts of next segment TNCPS is received on a subtracter 851, followed in series by an amplifier 853, a translator 856 (TRANS) and a motion estimator 857 (EST), at an output of which the real number RNBC(RP) of candidates for all processed regulator parts of next segment is available. The target that is used for the regulator is the number TNCPS of candidates for all the regulator parts that have been processed within a given segment (this target linearly increases with the number of processed regulator parts). A flow-chart of such a progress-based regulator using segment-based load targets is depicted in FIG. 9.

It must be finally indicated that there are numerous ways of implementing functions by means of items of hardware or software, or both. In this respect, the drawings are very diagrammatic, each one representing only one possible embodiment of the invention. Thus, although a drawing shows different functions as different blocks, this by no means excludes that a single item of hardware or software carries out several functions. Nor does it exclude that an assembly of items of hardware or software or both carry out a function.

The remarks made herein before demonstrate that the detailed description, with reference to the drawings, illustrates rather than limits the invention. There are numerous alternatives, which fall within the scope of the appended claims. Any reference sign in any claim should not be construed as limiting said claim. The word “comprising” does not exclude the presence of other elements or steps than those listed in a claim. The word “a” or “an” preceding an element or step does not exclude the presence of a plurality of such elements or steps.

1. In a media signal processing system, a method of processing a media signal available in the form of successive sets of media data packets, said processing method performing one or a plurality of functions among which at least one of them can be carried out with different levels of scalability resulting in different output qualities and resource demands, said method further comprising the steps of:
requesting a resource to provide a plurality of system outputs;
allocating a predetermined budget to the method in order to enable operating the method at a given level of scalability;
measuring a so-called progress that takes into account the data that have been processed;
measuring at least one media processing specific resource used during operation of the method;
on the basis of regulation parameters consisting of said allocated budget and said measurements, performing a load regulation by allocating modified resources for media signal processing.

2. A method according to claim 1, in which said regulation parameters are adapted within a frame with regular borders.

3. A method according to claim 1, in which said regulation parameters are adapted within a frame subdivided into segments in a regular grid, a separate budget being allocated to at least one of said segments.

4. A method according to claim 1, in which said regulation parameters are adapted within a frame subdivided into segments in a regular grid, a separate budget being allocated to each of said segments on the basis of content dependent segment properties.

5. A method according to claim 1, in which said regulation parameters are adapted within a frame subdivided into irregular parts, a specific budget being allocated to each of said irregular parts.

6. A media signal processing system for processing successive sets of video data packets and comprising one or a plurality of functional circuits among which at least one of the functions performed by said circuits can be carried out with different levels of scalability resulting in different output qualities and resource demands, said system comprising a regulation device consisting of a feedback control loop provided for dynamically changing the resource needs of the system as a function of a so-called deviation applied to at least one variable parameter of said scalable(s) function(s) and calculated by means of a computation of the difference between expected and real usage during an assigned period.

7. Application of the media signal processing method of claim 1 to a load regulation method for use in a resource-scalable motion estimator testing a target number of vector candidates and including a load-balancing regulation for an input video data stream consisting of successive frames that comprise successive lines of pixels and are subdivided into contiguous blocks, said load regulation method comprising the steps of:
requesting a resource to provide a plurality of system outputs in the form of a given number of estimated motion vector candidates
allocating a predetermined budget per frame in order to enable operating at a defined quality level;
measuring a so-called progress that takes into account the data that have been processed;
measuring the resource used during operation of the method;
on the basis of regulation parameters consisting of said allocated budget and said measurements, performing a load regulation by allocating modified resources for said media signal processing.

8. A load regulation method according to claim 7, for use in a resource-scalable motion estimator testing a target number of vector candidates and including a load-balancing regulation for an input video data stream consisting of successive frames that comprise successive lines of pixels and are subdivided into contiguous blocks, said load regulation method comprising the steps of:
estimating a given number of estimated motion vector candidates;
allocating a predetermined budget per frame to enable operating at a defined quality level;
measuring a so-called progress taking into account the data that has been processed;
weighting the target number of vector candidates with said progress;
determining the difference between the given number of vector candidates at the output of the motion estimator and the weighted target number of vector candidates;
performing a regulation of the load of said motion estimator on the basis of said difference and said measurement.

9. A method according to claim 8, in which said progress is determined by a ratio between a number of processed block lines and the total number of block lines in a frame.

10. A method according to claim 9, in which said regulation parameter is a block-hopping threshold affecting the number of vector candidates to be tested.

11. A computer system for performing a method according to claim 8.

12. A computer program product comprising program code means stored on a computer readable medium for performing a method according to claim 8 when the computer program is run on a computer.

13. A resource-scalable motion estimator provided for testing a target number of vector candidates associated to a video data stream consisting of frames that comprise successive lines of pixels and are subdivided into contiguous blocks, said motion estimator comprising:
motion estimating means, provided for delivering a given number of vector candidates;
allocating means, provided for defining a predetermined budget per frame to enable operating at a defined quality level;
measuring means, provided for calculating a so-called progress determined by a ratio between a number of processed block lines and the total number of blocks lines in a frame;
weighting means, provided for weighting the target number of vector candidates with said progress;
computing means, provided for determining the difference between the real number of vector candidates at the output of the motion estimator and the weighted target number of vector candidates;
control means, provided for changing a regulation parameter of the load of the motion estimator on the basis of said difference.

14. A motion estimator according to claim 13, in which said regulation parameter is a block-hopping threshold affecting the number of vector candidates to be tested.

15. Application of the media processing method of claim 1 to a load regulation method for use in a sharpness enhancement process, said load regulation method comprising the steps of:
requesting a resource to provide a plurality of system outputs in the form of a given number of block activities and associated decisions;
allocating a predetermined budget per frame in order to enable operating at a defined quality level;
measuring a so-called progress that takes into account the data that have been processed;
measuring the resource used during operation of the method
on the basis of regulation parameters consisting of said allocated budget and said measurements, performing a load regulation by allocating modified resources for said media signal processing.

16. A sharpness enhancement device for carrying out the method according to claim 15.
